(19) United States
(12) Patent Application Publication
(10) Pub. No.: US 2005/0197891 A1
(43) Pub. Date: Sep. 8, 2005

(54) Transport, dispatch & entertainment system and method

(76) Inventor: Matthew Intihar, Pembroke Pines, FL (US)

Correspondence Address: GOLD & RIZVI, P.A., 600 N. PINE ISLAND ROAD, SUITE 450, PLANTATION, FL, 33324-1311, US

(21) Appl. No.: 11/070,803

(22) Filed: Mar. 2, 2005

Related U.S. Application Data
(60) Provisional application No. 60/549,841, filed on Mar. 3, 2004.

(51) Int. Cl. H04M 1/24

(52) U.S. Cl. 705/13

(57) ABSTRACT

A transport and entertainment package dispatch system and method is disclosed. The system includes multiple dispatch checkpoints arranged between a group gathering point and an entertainment destination for the efficient and expeditious processing and dispatch of customers from the group gathering point to the entertainment destination. Each dispatch checkpoint functions as an electronic turnstile at which the customers' pre-paid and authorized status is verified prior to dispatch of the customers through the next checkpoint. A main server database loaded with package and customer identification information interfaces with each of the dispatch checkpoints. A PDA (Personal Digital Assistant) is typically used at each checkpoint to exchange information with the main server database during customer processing and dispatching.

### CROSS REFERENCE TO RELATED APPLICATIONS

This application claims the priority of co-pending U.S. provisional patent application Ser. No. 60/549,841, filed on Mar. 3, 2004 by the same inventor.

### FIELD OF THE INVENTION

The present invention relates generally to transport and entertainment (T&E) packages used in the tourism industry. More particularly, the present invention relates to a novel dispatch, transport and entertainment (DT&E) package system which provides a central control or management scheme for each of multiple dispatch checkpoints in an individual or group transport and entertainment package to facilitate the efficient and expeditious dispatch of customers through the checkpoints to an entertainment destination or destinations.

### DESCRIPTION OF THE PRIOR ART

Travel and entertainment (T&E) packages are common in the tourism and entertainment industries. T&E packages are frequently offered by travel agents, cruise lines and other entities, which offer travel, entertainment and tourism options to customers. In a typical T&E package, customers are offered various options on some, most or all aspects of the package. For example, customers may have the option of selecting the date, time and mode of transportation from a gathering checkpoint to an entertainment facility or resort, as well as which of a variety of entertainment destinations or outlets to take part in at the facility or resort. Frequently, customers must pass through a number of manual turnstiles or be otherwise processed at each of multiple checkpoints from the gathering checkpoint to the entertainment destinations.

Travel and entertainment packages vary depending on the country of origin and the agency or management entity that offers the packages. Generally, the manual public processing of customers in a T&E package results in customer dissatisfaction due to slow manual turnstile processing methods. Management personnel can have direct dispatch control over the dispatch processing of customers in a T&E package, or alternatively, can employ or contract a third party to process the customer dispatching. The addition of a third party, however, typically increases the cost of the T&E package.

One example of a T&E package includes a package for both transportation and entertainment entry for an amusement park. The transportation available to the package customers may be a part of the entertainment in the form of talking or informative transportation, such as by air travel, taxi, bus, ferry or boat ride. The customers purchase the amusement ticket packages for both transportation and amusement entry. Each customer is issued a physical ticket, which is used to gain entry to the entertainment package purchased. At the transportation dispatching area, where the customers will embark on transportation that will take the customers to the amusement, each customer presents the ticket at a first turnstile location, through which the customers gain access to a bus or taxi, for example. The bus or taxi takes the group of customers to a public entertainment entry area, at which point the customers pass through a second turnstile location to gain access to the entertainment. The customers may subsequently pass through third, fourth or fifth turnstile locations to gain access to various entertainment destinations within the entertainment facility. Typically, there are internal controls that are unique to each dispatch package to facilitate manual processing of the customers through the turnstile checkpoints.

Dispatching of the customers for transportation at the transportation dispatching area is a labor-intensive and slow process. The grouping of customers and the counting of tickets are entirely manual, and dispatch personnel are required to perform process authorization for each person in the group in order for each person to access the waiting bus, for example. As a result, customers frequently become dissatisfied with time delays associated with the transportation dispatch process.

U.S. Patent Application Publication No. 2002/0055872, dated May 9, 2002, describes a user services and information management system and method which may be applied to a passenger information system for a cruise ship. The passenger information system may include a communications network, a server coupled to the communications network, and a terminal device including a processor and a display. The terminal device communicates with the communications network and is configured to access information from the server. A user interface is provided on the display of the terminal device. The user interface includes user-selectable options and is configured to selectively provide passenger information to a cruise ship passenger.

U.S. Patent Application Publication No. 2003/0069763, dated Apr. 10, 2003, discloses a business method and system for providing status information to patrons of a public facility through patron virtual ticket devices. A message database stores standard and customized information messages. The information messages may be sent on request, at predetermined times, or upon the occurrence of a pre-selected event.

T&E package management personnel are increasingly seeking new methods and technology to improve customer satisfaction. Customer satisfaction leads to repeat business, as well as increased revenue, as satisfied customers take advantage of higher-priced packages offered by the package-selling agency.

Accordingly, there is a well-established need for a new and improved system and method which provides a central control or management scheme for the multiple checkpoints in a dispatch, transport and entertainment (DT&E) package and which utilizes advanced technology in the processing of customers at the checkpoints in order to facilitate the expeditious dispatching of customers from a transportation dispatch area to a final entertainment or resort destination or to any of multiple entertainment or resort destinations offered in the package.

### SUMMARY OF THE INVENTION

The invention is directed to a novel dispatch, transport and entertainment (DT&E) package system which provides a central control or management scheme for each of multiple dispatch checkpoints in an individual or group transport and entertainment package and facilitates the efficient and speedy processing or dispatch of customers through the checkpoints to the destination or destinations.

In one general aspect of the present invention, a single management entity controls all aspects of the various dispatch checkpoints from the transportation dispatch area to a single entertainment destination or to each of multiple entertainment destinations in an entertainment facility, resort or system.

In a further aspect of the present invention, an agency or management issues a T&E package ticket to each customer or the customer obtains a T&E package ticket via the Internet.

In a still further aspect of the present invention, PDAs (Personal Digital Assistants) are used to process customers at each of the dispatch checkpoints in the system.

In still a further aspect of the present invention, each customer presents the physical T&E package ticket, obtained through the management entity or the Internet, at a PDA located at a first dispatch checkpoint and the PDA issues a group voucher for the group of customers to gain access to the next dispatch checkpoint in the system.

In yet another aspect of the present invention, the transport and entertainment package dispatch system can be carried out in multiple phases, in which:
Phase I of the system involves retrieval of a physical package ticket from each customer, use of a PDA to count customers in a group at a gathering point or transport dispatch area and production of a group voucher for entry of the group to the entertainment facility or resort;
Phase II of the system involves issuance of a customer ID, which may include turnstile dispatch, transportation and entertainment entries, to each customer in the group, use of a PDA to read the customer ID and verify the pre-paid status of each customer, and authorization and recordation of a customer turnstile date and time entry point; and
Phase III of the system involves use of the PDA to read the customer ID and provide access of the customer to the entertainment facility or resort without the need of the customer to present a package ticket.

In another aspect of the present invention, phase I of the system includes the use of a PDA with printer to provide turnstile DT&E dispatch and transportation internal documents or vouchers for accounting purposes.

In yet another aspect of the present invention, PDA information includes entertainment specifics such as entertainment entry, location and seat number, for example.

In another aspect of the present invention, the system may include a premium or expedited or express dispatch passage option, which places the customer in an expedited turnstile.

In yet another aspect of the present invention, the PDA system reads a customer ID to verify the customer T&E ticket selection, which may include all aspects of the dispatch, transportation and entertainment passage requirements.

In still another aspect of the present invention, PDAs are used at various turnstiles or checkpoints, which may include a gathering checkpoint, a transportation checkpoint and one or multiple entertainment checkpoints.

In a still further aspect of the present invention, a customer ID can be custom-issued to the customer for the T&E event or can be in the form of a credit card ID or debit card ID, for example.

These and other aspects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 is a schematic view illustrating an illustrative embodiment of the transport and entertainment dispatch system of the present invention; and

FIG. 2 is a schematic view illustrating various communication network options suitable for implementation of the dispatch, transport and entertainment (DT&E) system of the present invention.

### DETAILED DESCRIPTION OF THE PREFERRED EMBODIMENTS

Shown throughout the Figures, the present invention is generally directed to a novel dispatch, transport and entertainment (DT&E) package system which provides a central control or management scheme or entity for each of multiple dispatch checkpoints in an individual or group transport and entertainment package and facilitates the efficient and expeditious dispatch of customers through the checkpoints to an entertainment destination or destinations.

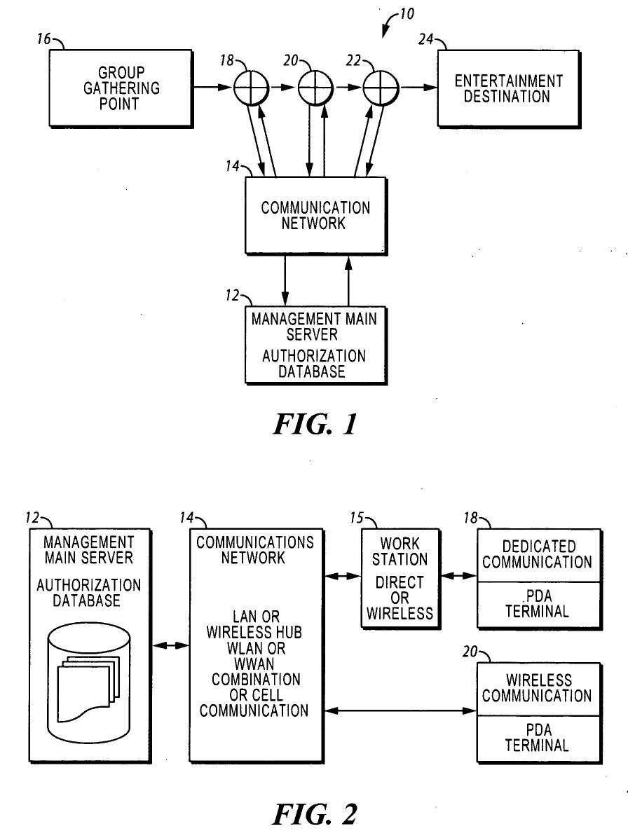

Referring initially to the schematic diagram of FIG. 1, an illustrative embodiment of a dispatch, transport and entertainment (DT&E) package dispatch system, hereinafter system, of the present invention is generally indicated by reference numeral 10. The system 10 includes a management main server authorization database 12, which receives and stores T&E package purchase information, as hereinafter further described. After a customer purchases a T&E package, the package purchase information, such as the name of the customer, the type of transportation to be used to transport the customer to the entertainment destination or destinations, the entertainment destination or destinations to be visited by the customer and a customer identification, for example, are entered into the database 12, as hereinafter further described.

The database 12 interfaces with a communication network 14 which, in turn, interfaces with each of multiple dispatch checkpoints. These are shown in FIG. 1 as a first dispatch checkpoint 18, a second dispatch checkpoint 20 and a third dispatch checkpoint 22. However, it is understood that the database 12 may interface with any number of dispatch checkpoints, less or greater than three in number, in the system 10. The communication network 14 provides a conduit through which the management main server 12 communicates with the dispatch checkpoints 18, 20, 22, and vice-versa. As illustrated in the block diagram of FIG. 2, the communication network 14 may interface indirectly with a dispatch checkpoint, such as with the first dispatch checkpoint 18 through an intermediary workstation 15. Alternatively, the communication network 14 may interface directly with a dispatch checkpoint, without a workstation as an intermediary, such as through wireless communication with the second dispatch checkpoint 20, as further illustrated in FIG. 2.

The communication network 14 can consist of many variations depending on the management entity's requirements and current technology. It can be as basic as a Local Area Network (LAN-Ethernet), which supports communications between the management main server 12 and the workstations. To support wireless communications, it can be as simple as a wireless router (WLAN) or wireless wide area network (WWAN).

In the schematic diagram of FIG. 1, the first dispatch checkpoint 18, second dispatch checkpoint 20 and third dispatch checkpoint 22, represent electronic turnstile checkpoints through which each of multiple customers, having purchased a T&E package, are sequentially processed from a group gathering point 16 to an entertainment destination or destinations 24. The entertainment destination 24 may be entertainment facility, resort, amusement park, cruise ship, shopping area, shore excursion or other entertainment outlet. As an example, the first dispatch checkpoint 18 may represent an initial crowd flow control checkpoint through which the customers are processed from the initial gathering point 16, which may be a parking lot or other arrival spot to which the customers of a group initially arrive by disembarking a private vehicle, bus, taxi, airplane or cruise ship or by walking, for example. The second dispatch checkpoint 20 may be a transportation checkpoint through which the customers or the group are processed prior to boarding a bus, taxi or other mode of transportation to the entertainment destination 24. The third dispatch checkpoint 22 may be an entertainment checkpoint through which the customers are processed prior to entering the entertainment facility, resort, amusement park, cruise ship, shore excursion or other entertainment destination 24. The system 10 may include additional dispatch checkpoints (not illustrated) that are provided within the entertainment destination 24 in the event that it is necessary to process the customers, either individually or as a group, among any or all of multiple entertainment outlets within the entertainment destination 24.

A PDA (Personal Digital Assistant) is typically used to perform the various customer processing and identification tasks at each dispatch checkpoint 18, 20, 22. The PDA (not shown) typically contains pre-programmed information such as the transportation mode, customer ID type, ID Number, entertainment location, entertainment seat number, etc., for each customer. Each PDA communicates bi-directionally with the management main server 12 through the communication network 14, either via wireless communication with the communication network 14 or through a workstation 15, as heretofore noted with respect to FIG. 2. A PDA is a portable, battery-operated, hand-held computer terminal with standard optional attachments. PDAs are commercially available and offer various levels of durability, communications, volatile and non-volatile memory, sensors, bar code scanner, magnetic strip reader, finger print scanning, sub-dermal sensing and portable printer options. The options shown in FIG. 2 include a direct-connected rs232c or USB communication connection to the workstation 15 and a remote wireless LAN communication or Wireless Wide Area Network with the communication network (WLAN or WWAN). PDA customer ID sensing and identification options include, but are not limited to, magnetic strip reader and bar code reader capability for deciphering coded information on a customer ID, as well as other remote sensing customer identification options such as wristbands, sub-dermal implant identification, finger print identification and smart cards. It will be understood that the various means of customer identification identified throughout this specification are merely exemplary—the invention is not intended to be so limited. To the contrary, it will be apparent to those skilled in the art that the system of the present invention is particularly configured having an inherent flexibility such that it can be adapted to incorporate virtually any means of customer identification, including, particularly, any existing or future types of biometric sensing technology useful for such identification purposes.

Bi-directional communication between each PDA and the management main server 12 provides a method of exchanging authorization and turnstile date-time stamp information between the management main server 12 and the dispatch checkpoints 18, 20, 22. Bi-directional communication of each PDA with the management main server 12 may be accomplished in one of several ways: (1) RS232c or USB interface; (2) IR interface; (3) WLAN interface; or (4) WWAN interface, for example. In a dedicated communication mode, the PDA communicates with the management main server 12 via the workstation 15 through a serial communications port, which may be an IR, USB or RS232 interface, in non-exclusive particular. In a wireless communication mode, PDA wireless communication options may include IEEE 802.11g (WLAN) or cellular communications (WWAN), in non-exclusive particular.

Communication between each PDA and the workstation 15 is typically carried out according to the following steps: (1) the workstation 15 is provided with access to the management main server 12 containing the T&E package database; (2) bidirectional communication capability is established between the PDA and the workstation 15, permitting the operating personnel of the workstation 15 to program/load the PDA with the customer DT&E package information, which will be hereinafter further described, and further facilitating transmission of customer checkpoint utilization date and time information from each dispatch checkpoint 18, 20, 22 through the workstation 15 and to the management main server 12 for application analysis; and (3) loading information into and retrieving information from each PDA. The bidirectional communication capability of each PDA may be accomplished using an RS232c interface, an IR interface, a WLAN interface or a WWAN interface, for example.

In implementation of the system 10, customers initially purchase a T&E package from an agency or management entity, which offers the packages. Each customer may purchase the T&E package directly from the sales staff or representatives of the agency or entity, for example. Alternatively, the customer may purchase the T&E package over the Internet. The T&E package may include transportation, food or shopping stops and entry to an amusement park or entertainment facility, as well as the return trip, for example. Alternatively, the T&E package may include travel and luggage entry into one country, lodging, and travel to entertainment or work destinations within the country. The T&E package may further include the customer's return trip to their country of origin. The package is paid for in advance and each customer is provided a Customer ID identification option, which may be in the form of a credit card, debit card, computer-printed paper ticket with bar code, printed ticket stock with optional bar code or magnetic strip identification, or a unique or custom-issued customer ID card with optional magnetic strip or bar code identification (such as a cruise ship passenger sign and sail card), finger print, or sub-dermal ID, for example.

The T&E package purchase information for the T&E packages, which includes such information as the time and date of the T&E engagement and the name and other identification indicia of each customer, is entered into the management main server 12. The management main server 12 is then used to load the T&E package purchase information, along with the identification indicia of each customer, into the PDA. When the time and date of the T&E engagement arrives, the customers who pre-purchased the T&E packages gather at the group gathering point 16, having arrived by disembarking a private vehicle, bus, taxi, airplane or cruise ship or by walking, for example. Management personnel or a signed portal (not shown) identifies to the customers the first dispatch checkpoint 18 as the appropriate initial checkpoint for processing.

The system 10 can be implemented in multiple phases, depending on the technology available to the management entity or personnel. In phase I of system implementation, management personnel use a PDA to count the customers in the group at the first dispatch checkpoint 18. The PDA then prints a group voucher for passage of the group through the first dispatch checkpoint 18. At the second dispatch checkpoint 20, the PDA counts the group and prints a group voucher for passage of the group through the second dispatch checkpoint 20, onto a bus or other mode of transportation and to the third dispatch checkpoint 22. At the third dispatch checkpoint 22, the PDA counts the group and prints a group voucher for passage of the group through the third dispatch checkpoint 22 and entry of the group into the entertainment destination 24. Each PDA also records and prints DT&E dispatch and transportation internal documents for accounting purposes. PDA device requirements include operator entry of customer accounts, entertainment name and management name and date, for example. A customer ID is not used in phase I.

In phase II of system implementation, each customer in the group, after gathering at the group gathering point 16, is initially processed through the first dispatch checkpoint 18. Accordingly, at the first dispatch checkpoint 18, the PDA is used to scan, swipe, sense, finger print, or otherwise decipher the coded information on each customer's ID. The PDA then searches its programming for the Customer ID to verify the pre-paid and authorized status of the customer. The PDA records each Customer ID entry and authorizes entry of the customer through the first dispatch checkpoint 18. The paper group voucher of phase I implementation, described above, is replaced in phase II by an electronic PDA entry as a VTE (Virtual Ticket Entry) authorization, which is confirmed by the customer ID at the checkpoints 18, 20, 22.

In phase II implementation, at the second dispatch checkpoint 20, the PDA is used to scan, swipe, sub-dermal sense, finger print or otherwise decipher each customer's ID to authorize progression of each customer through the second dispatch checkpoint 20. After authorization and progression of each customer through the second dispatch checkpoint 20, the PDA prints a group transportation voucher to provide the customers access to the bus or other mode of transportation.

The bus or other transportation transports the customers to the third dispatch checkpoint 22. At the third dispatch checkpoint 22, the PDA is again used to scan, swipe, sub-dermal sense, finger print or otherwise decipher each customer's ID to authorize passage of the customers through the third dispatch checkpoint 22 and to the entertainment destination 24. At each of the dispatch checkpoints 18, 20, 22 in phase II implementation, the PDA records the date and time that each customer progresses through each dispatch checkpoint 18, 20, 22.

In phase III implementation, the document/voucher aspect of the process is eliminated completely. Accordingly, as in phase II implementation, phase III involves using a PDA to scan, swipe, sub-dermal sense, finger print or otherwise decipher each customer's ID at each dispatch checkpoint 18, 20, 22 to confirm and authorize passage of the customer through the checkpoint. No individual or group voucher is necessary to authorize access of the customers to the bus or other transportation at the second dispatch checkpoint 20.

In phase IV implementation, the customer's ID is used both for customer identification and authorization charges and for store credit or debit authorizations for the purchase of goods or services at stores or outlets within the entertainment destination 24. In automated phase IV applications, date and time checkpoint information for each customer is transmitted from each PDA to the management main server 12. The information can be used in several applications, such as: (1) verification that the customer has used the various features of the T&E package; (2) customer date and time tracking for analysis of checkpoint performance, which enables management to modify various processing aspects of the system 10 to improve procedures and performance; and (3) establishment of invoicing and billing accounting entries, including third party dispatch, management staff payment schemes based on performance, entertainment payments, or any other parameters which may relate to the processing and dispatch of customers through the system 10.

The DT&E package system 10 of the present invention may be implemented from the outset according to any of the phase implementations described above, or alternatively, may be implemented with incremental use in ascending order throughout the various phases as new levels of technology become available to the management entity. This incremental phase implementation scheme provides a trade-off for management's typically limited ability to train staff to implement technology levels of increasing complexity. Accordingly, the invention provides for the implementation of operational phases as a function of the availability of advancing technology, along with additional staff or personnel training with each additional phase level of technology.

The electronic, PDA-mediated dispatch checkpoint approach of the present invention streamlines and expedites management's dispatching or processing of package customers from the group gathering point 16 to the entertainment destination 24. In phase II and higher system implementation, management personnel use the PDA as an efficient dispatch authorization checkpoint tool for counting the customers in a group as well as reading, interpreting and verifying the coded information provided on the customer ID. The customers may proceed individually or in groups through each of the sequential dispatch checkpoints and utilization of the bus or other transportation mode, which transports the customers to the entertainment destination. If a customer proceeds individually, then the dispatching management personnel can provide methods by which the customer can be directed to the next dispatch checkpoint in the sequence. For example, a series of signs or a colored line may be used to guide the customers individually or as a group to the next turnstile.

The various phase implementations are not limited to processing and dispatching of customers through the dispatch checkpoints 18, 20 and 22, but can be extended to dispatch checkpoints provided within the entertainment destination 24 for the processing and dispatch of customers to entertainment outlets, entertainment shops, etc. Furthermore, in each of the phase implementations, the DT&E package may include transportation of the customers from the entertainment destination 24, back to the group gathering point 16. Additional dispatch checkpoints may be utilized for the purpose of verifying and authorizing customer utilization of the return transportation services.

As an example of a phase III implementation of the system 10, package customers could be located in the USA or the Caribbean. The customers purchase a T&E package that includes a sightseeing ferryboat ride having a guide that discusses historical sites on a waterway as the customers proceed to an entertainment destination. The ferryboat ride ends near the entertainment destination, such as on a private beach or concert located just off the waterway. If the DT&E package includes a ship shore excursion, the customer ID may be a passenger sign and sail card, which provides for bar code or magnetic swipe of the customer ID. If the T&E package includes an event in the USA and the customer utilizes a credit card or custom issue card, then the customer ID may include that credit card number for customer identification purposes. In this case, the dispatcher, ferryboat operator and entertainment destination all have a PDA for customer identification purposes. The customer ID typically includes sensing, thumb print ID, sub-dermal sensing, bar code scanning, and/or magnetic strip-reading that permits the PDA to identify the customer ID.

After arrival of the customers at the group gathering point 16, the management personnel use the PDA to ID the customer via magnetic swipes, optical scans, sensing, finger print scan, and/or sub-dermal sensing the ID of the customers to provide the customers access through the first dispatch checkpoint 18. This permits the customers, either individually or as a group, to proceed to the second dispatch checkpoint 20, which facilitates entry to the sightseeing ferryboat. Accordingly, at the second dispatch checkpoint 20, management personnel again uses the PDA to ID each customer using the PDA to verify the authorization status of the customers. The verified customers then proceed through the second dispatch checkpoint 20 to embark on the ferryboat, where the customers wait for launch of the boat.

After the ferryboat transports the customers to the entertainment destination 24, the customers disembark the boat and are guided (such as by management personnel, signs or a colored line, for example) to the third dispatch checkpoint 22. At the third dispatch checkpoint 22, each customer presents his or her customer ID which management personnel verify using the PDA to authorize passage of the customer through the third dispatch checkpoint 22. The customers are then free to enter the entertainment destination 24.

As another example of a phase III implementation of the system 10, package customers are processed and dispatched for a ship shore excursion on an island of one of the Caribbean countries or U.S. territories, for example. The customers purchase the T&E packages from a purser's office on a cruise ship. The T&E packages include bus transportation and entertainment on the island. In this case, the dispatcher, bus operator and place of entertainment each utilize a PDA for customer identification purposes.

As they disembark the cruise ship at the time indicated for the excursion, the passengers enter the dispatch area or group gathering point 16. The customers observe a signed area that identifies their DT&E package, and present their customer ID (sign-and-scale) cards to the management personnel at the first dispatch checkpoint 18. The customer ID cards are swiped or scanned to verify the pre-paid status of each customer and authorize each customer to proceed through the first dispatch checkpoint 18. The customers are then directed through the second dispatch checkpoint 20 in a second verification and authorization step, and then board a bus or tram, for example. On the bus or tram, the customers may be provided with optional package provisions such as a verbal guided tour as they proceed toward the entertainment destination 24. After disembarking the bus or tram, the customers are guided to the third dispatch checkpoint 22, where the customers' ID's are verified and the customers are allowed to pass through the third dispatch checkpoint 22 to the entertainment destination 24.

1. A dispatch, transport and entertainment (DT&E) package system comprising:
a group gathering point for the gathering of customers;
an entertainment destination spaced from said group gathering point;
a management main server authorization database for containing information related to the customers; and
at least one dispatch checkpoint between said group gathering point and said entertainment destination and interfacing with said management main server for processing the customers.

2. The system of claim 1 further comprising a communication network interfacing with said at least one dispatch checkpoint and said management main server.

3. The system of claim 2 further comprising a workstation interfacing with said communication network and said at least one dispatch checkpoint and wherein said communication network and said at least one dispatch checkpoint interface indirectly through said workstation.

4. The system of claim 2 wherein said communication network and said at least one dispatch checkpoint interface directly.

5. The system of claim 2 wherein said communication network comprises a local area network.

6. The system of claim 2 wherein said communication network comprises a wireless router.

7. The system of claim 1 wherein said entertainment destination is an entertainment facility, a resort, an amusement park, a cruise ship, a shopping area or a shore excursion.

8. The system of claim 1 wherein said at least one dispatch checkpoint comprises a plurality of dispatch checkpoints provided in sequential order between said group gathering point and said entertainment destination.

9. A dispatch, transport and entertainment (DT&E) package system comprising:
a group gathering point for the gathering of customers;
an entertainment destination spaced from said group gathering point;
a management main server authorization database for containing information related to the customers; and
a plurality of dispatch checkpoints provided in sequential order between said group gathering point and said entertainment destination and interfacing with said management main server for processing the customers, each of said plurality of dispatch checkpoints comprising a personal digital assistant interfacing with said management main server authorization database.

10. The system of claim 9 further comprising a communication network interfacing with said plurality of dispatch checkpoints and said management main server.

11. The system of claim 10 further comprising a workstation interfacing with said communication network and said plurality of dispatch checkpoints and wherein said communication network and said plurality of dispatch checkpoints interface indirectly through said workstation.

12. The system of claim 10 wherein said communication network and said plurality of dispatch checkpoints interface directly.

13. The system of claim 10 wherein said communication network comprises a local area network.

14. The system of claim 10 wherein said communication network comprises a wireless router.

15. The system of claim 9 wherein said entertainment destination is an entertainment facility, a resort, an amusement park, a cruise ship, a shopping area or a shore excursion.

16. The system of claim 9 wherein said plurality of dispatch checkpoints comprises an initial crowd control checkpoint, a transportation checkpoint and an entertainment checkpoint, respectively.

17. A method of processing customers from a group gathering point to an entertainment destination in a travel and entertainment package, comprising:
providing travel and entertainment package information for each of said customers;
storing said information in a database;
gathering said customers at said group gathering point;
processing said information; and
transporting said passengers to said entertainment destination.

18. The method of claim 17 wherein said processing said information comprises counting said customers and printing a group voucher for said customers.

19. The method of claim 17 wherein said processing said information comprises deciphering coded information on customer ID cards of said customers, respectively.

20. The method of claim 17 wherein said processing said information comprises providing a plurality of sequential dispatch checkpoints between said group gathering point and said entertainment destination.
